(19) United States
(12) Patent Application Publication
(10) Pub. No.: US 2026/0082370 A1
(43) Pub. Date: Mar. 19, 2026

(54) AVAILABLE SLOT COUNTING FOR HYBRID AUTOMATIC REPEAT REQUEST ACKNOWLEDGEMENT SLOT OFFSET

(71) Applicant: QUALCOMM Incorporated, San Diego, CA (US)

(72) Inventors: Mostafa KHOSHNEVISAN, San Diego, CA (US); Gokul SRIDHARAN, Sunnyvale, CA (US); Jing SUN, San Diego, CA (US)

(21) Appl. No.: 18/890,619

(22) Filed: Sep. 19, 2024

(51) Int. Cl. H04W 72/0446; H04W 72/232

(52) U.S. Cl. CPC H04W 72/0446; H04W 72/232

(57) ABSTRACT

Methods, systems, and devices for wireless communications are described. A wireless communications system may support techniques to indicate a slot offset which counts slots that are available for uplink transmission. To determine a slot for transmitting feedback on an uplink control channel corresponding to a downlink shared channel, a slot offset may only count available uplink slots for uplink transmission. The criteria for an available uplink slot may be configurable. A slot may be counted as available if the slot includes at least one uplink or flexible symbol. A slot may be counted as available if the slot can accommodate an uplink control channel resource to transmit the feedback. An available slot may be non-overlapping with a synchronization signal block. The network may configure a pattern associated with which slots are to be counted as available slots.

### INTRODUCTION

The following relates to wireless communications that pertain to available slot counting for hybrid automatic repeat request acknowledgement slot offset. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a network entity is described. The method may include receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, receive, based on the downlink control information, the downlink shared channel transmission, and transmit feedback information during the uplink channel transmission occasion based on the slot offset.

A network entity for wireless communication is described. The network entity may include one or more memories storing processor executable code, and one or more processors coupled with the one or more memories. The one or more processors may individually or collectively be operable to execute the code to cause the network entity to receive downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, receive, based on the downlink control information, the downlink shared channel transmission, and transmit feedback information during the uplink channel transmission occasion based on the slot offset.

Another network entity for wireless communication is described. The network entity may include means for receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, means for receiving, based on the downlink control information, the downlink shared channel transmission, and means for transmitting feedback information during the uplink channel transmission occasion based on the slot offset.

A non-transitory computer-readable medium storing code for wireless communication is described. The code may include instructions executable by one or more processors to receive downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, receive, based on the downlink control information, the downlink shared channel transmission, and transmit feedback information during the uplink channel transmission occasion based on the slot offset.

In some examples of the method, network entities, and non-transitory computer-readable medium described herein, the downlink control information indicates the slot offset.

In some examples of the method, network entities, and non-transitory computer-readable medium described herein, each respective slot of the quantity of one or more available slots for uplink transmission includes a respective set of multiple symbols including at least one of one or more uplink symbols or one or more flexible symbols.

In some examples of the method, network entities, and non-transitory computer-readable medium described herein, each respective slot of the quantity of one or more available slots for uplink transmission includes a respective set of one or more symbols that does not overlap with a synchronization signal block and each respective set of one or more symbols includes at least one of one or more uplink symbols or one or more flexible symbols.

In some examples of the method, network entities, and non-transitory computer-readable medium described herein, each respective slot of the quantity of one or more available slots for uplink transmission exclusively includes uplink symbols, flexible symbols, or a combination thereof.

In some examples of the method, network entities, and non-transitory computer-readable medium described herein, each respective slot of the quantity of one or more available slots may be non-overlapping with a synchronization signal block.

In some examples of the method, network entities, and non-transitory computer-readable medium described herein, each slot of the quantity of one or more available slots for uplink transmission exclusively includes a quantity of uplink symbols, flexible symbols, or a combination thereof, that corresponds to the uplink channel transmission occasion.

In some examples of the method, network entities, and non-transitory computer-readable medium described herein, each respective slot of the quantity of one or more available slots may be non-overlapping with a synchronization signal block.

In some examples of the method, network entities, and non-transitory computer-readable medium described herein, each slot of the quantity of one or more available slots for uplink transmission excludes downlink symbols or does not exclusively include downlink symbols.

Some examples of the method, network entities, and non-transitory computer-readable medium described herein may further include operations, features, means, or instructions for receiving control information that indicates a pattern, where the quantity of one or more available slots for uplink transmission may be based on the pattern.

Some examples of the method, network entities, and non-transitory computer-readable medium described herein may further include operations, features, means, or instructions for receiving control information that indicates a set of one or more slot offsets associated with the quantity of one or more available slots for uplink transmission, where the slot offset may be from the set of one or more slot offsets.

Some examples of the method, network entities, and non-transitory computer-readable medium described herein may further include operations, features, means, or instructions for determining a set of one or more downlink channel transmission occasions for a feedback codebook based on a set of differences between each slot index of a set of slot indexes and the slot offset, where the set of slot indexes corresponds to the set of one or more downlink channel transmission occasions.

Some examples of the method, network entities, and non-transitory computer-readable medium described herein may further include operations, features, means, or instructions for receiving control information and performing, based on the control information, a semi-static cell switch between a primary cell and a secondary cell, where the quantity of one or more available slots for uplink transmission includes available slots on at least one of the primary cell or the secondary cell.

A method for wireless communication by a network entity is described. The method may include outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, outputting, based on the downlink control information, the downlink shared channel transmission, and obtaining feedback information during the uplink channel transmission occasion based on the slot offset.

A network entity for wireless communication is described. The network entity may include one or more memories storing processor executable code, and one or more processors coupled with the one or more memories. The one or more processors may individually or collectively be operable to execute the code to cause the network entity to output downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, output, based on the downlink control information, the downlink shared channel transmission, and obtain feedback information during the uplink channel transmission occasion based on the slot offset.

Another network entity for wireless communication is described. The network entity may include means for outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, means for outputting, based on the downlink control information, the downlink shared channel transmission, and means for obtaining feedback information during the uplink channel transmission occasion based on the slot offset.

A non-transitory computer-readable medium storing code for wireless communication is described. The code may include instructions executable by one or more processors to output downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission, output, based on the downlink control information, the downlink shared channel transmission, and obtain feedback information during the uplink channel transmission occasion based on the slot offset.

In some examples of the method, network entities, and non-transitory computer-readable medium described herein, the downlink control information indicates the slot offset.

In some examples of the method, network entities, and non-transitory computer-readable medium described herein, each respective slot of the quantity of one or more available slots for uplink transmission includes a respective set of multiple symbols including at least one of one or more uplink symbols or one or more flexible symbols.

In some examples of the method, network entities, and non-transitory computer-readable medium described herein, each respective slot of the quantity of one or more available slots for uplink transmission includes a respective set of one or more symbols with a synchronization signal block and each respective set of one or more symbols includes at least one of one or more uplink symbols or one or more flexible symbols.

In some examples of the method, network entities, and non-transitory computer-readable medium described herein, each respective slot of the quantity of one or more available slots for uplink transmission exclusively includes uplink symbols flexible symbols, or a combination thereof.

In some examples of the method, network entities, and non-transitory computer-readable medium described herein, each respective slot of the quantity of one or more available slots may be non-overlapping with a synchronization signal block.

In some examples of the method, network entities, and non-transitory computer-readable medium described herein, each slot of the quantity of one or more available slots for uplink transmission exclusively includes a quantity of uplink symbols, flexible symbols, or a combination thereof, that corresponds to the uplink channel transmission occasion.

In some examples of the method, network entities, and non-transitory computer-readable medium described herein, each respective slot of the quantity of one or more available slots may be non-overlapping with a synchronization signal block.

In some examples of the method, network entities, and non-transitory computer-readable medium described herein, each slot of the quantity of one or more available slots for uplink transmission excludes downlink symbols or does not exclusively include downlink symbols.

Some examples of the method, network entities, and non-transitory computer-readable medium described herein may further include operations, features, means, or instructions for outputting control information that indicates a pattern, where the quantity of one or more available slots for uplink transmission may be based on the pattern.

Some examples of the method, network entities, and non-transitory computer-readable medium described herein may further include operations, features, means, or instructions for outputting control information that indicates a set of one or more slot offsets associated with the quantity of one or more available slots for uplink transmission, where the slot offset may be from the set of one or more slot offsets.

Some examples of the method, network entities, and non-transitory computer-readable medium described herein may further include operations, features, means, or instructions for determining a feedback codebook of the feedback information for a set of downlink channel transmission occasions based on a set of differences between each slot index of a set of slot indexes and the slot offset, where the set of slot indexes corresponds to the set of downlink channel transmission occasions.

Some examples of the method, network entities, and non-transitory computer-readable medium described herein may further include operations, features, means, or instructions for outputting control information and performing, based on the control information, a semi-static cell switch between a primary cell and a secondary cell, where the quantity of one or more available slots for uplink transmission includes available slots on at least one of the primary cell or the secondary cell.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports available slot counting for hybrid automatic repeat request acknowledgement slot offset in accordance with one or more aspects of the present disclosure.

FIG. 2 shows an example of a wireless communications system that supports available slot counting for hybrid automatic repeat request acknowledgement slot offset in accordance with one or more aspects of the present disclosure.

FIG. 3 shows an example of feedback codebook construction that supports available slot counting for hybrid automatic repeat request acknowledgement slot offset in accordance with one or more aspects of the present disclosure.

FIG. 4 shows an example of a cell switch procedure that supports available slot counting for hybrid automatic repeat request acknowledgement slot offset in accordance with one or more aspects of the present disclosure.

FIG. 5 shows an example of a process flow that supports available slot counting for hybrid automatic repeat request acknowledgement slot offset in accordance with one or more aspects of the present disclosure.

FIGS. 6 and 7 show block diagrams of devices that support available slot counting for hybrid automatic repeat request acknowledgement slot offset in accordance with one or more aspects of the present disclosure.

FIG. 8 shows a block diagram of a communications manager that supports available slot counting for hybrid automatic repeat request acknowledgement slot offset in accordance with one or more aspects of the present disclosure.

FIG. 9 shows a diagram of a system including a device that supports available slot counting for hybrid automatic repeat request acknowledgement slot offset in accordance with one or more aspects of the present disclosure.

FIGS. 10 and 11 show block diagrams of devices that support available slot counting for hybrid automatic repeat request acknowledgement slot offset in accordance with one or more aspects of the present disclosure.

FIG. 12 shows a block diagram of a communications manager that supports available slot counting for hybrid automatic repeat request acknowledgement slot offset in accordance with one or more aspects of the present disclosure.

FIG. 13 shows a diagram of a system including a device that supports available slot counting for hybrid automatic repeat request acknowledgement slot offset in accordance with one or more aspects of the present disclosure.

FIGS. 14 through 17 show flowcharts illustrating methods that support available slot counting for hybrid automatic repeat request acknowledgement slot offset in accordance with one or more aspects of the present disclosure.

### DETAILED DESCRIPTION

A network entity may transmit downlink control information to schedule a user equipment (UE) to receive a downlink shared channel message via a downlink shared channel. The downlink control information may indicate a slot offset between the downlink shared channel and an uplink control channel where the UE may transmit feedback for the downlink shared channel message. For an uplink control channel in a time division duplex (TDD) system, the network entity may schedule feedback in a next available special or uplink slot, as long as the downlink shared channel processing timeline is satisfied. Indicating a slot offset to an uplink slot based on all slots in TDD slot pattern may include counting downlink slots, which cannot be used to report feedback.

A wireless communications system described herein may support techniques to indicate a slot offset which counts slots that are available for uplink transmission. For example, to determine a slot for transmitting feedback on an uplink control channel corresponding to a downlink shared channel, a slot offset may only count available uplink slots for uplink transmission. The criteria for an available uplink slot may be configurable. In some examples, a slot may be counted as available if the slot includes at least one uplink or flexible symbol based on a TDD pattern. In some examples, a slot may be counted as available if the slot includes only uplink or flexible symbols based on a TDD pattern. In some examples, a slot may be counted as available if the slot can accommodate an uplink control channel resource to transmit the feedback (e.g., the slot has sufficient uplink or flexible symbols for the UE to report the feedback). An available slot may be non-overlapping with a synchronization signal block. In some examples, the network may configure (e.g., via higher layer signaling) a pattern associated with which slots are to be counted as available slots. Overhead for downlink control information to indicate a slot offset to an uplink control channel for reporting feedback can be reduced by only considering available uplink slots.

Aspects of the disclosure are initially described in the context of wireless communications systems. Aspects of the disclosure are then described with reference to feedback codebook construction, a cell switch procedure, and a process flow. Aspects of the disclosure are further illustrated by and described with reference to apparatus diagrams, system diagrams, and flowcharts that relate to available slot counting for hybrid automatic repeat request acknowledgement slot offset.

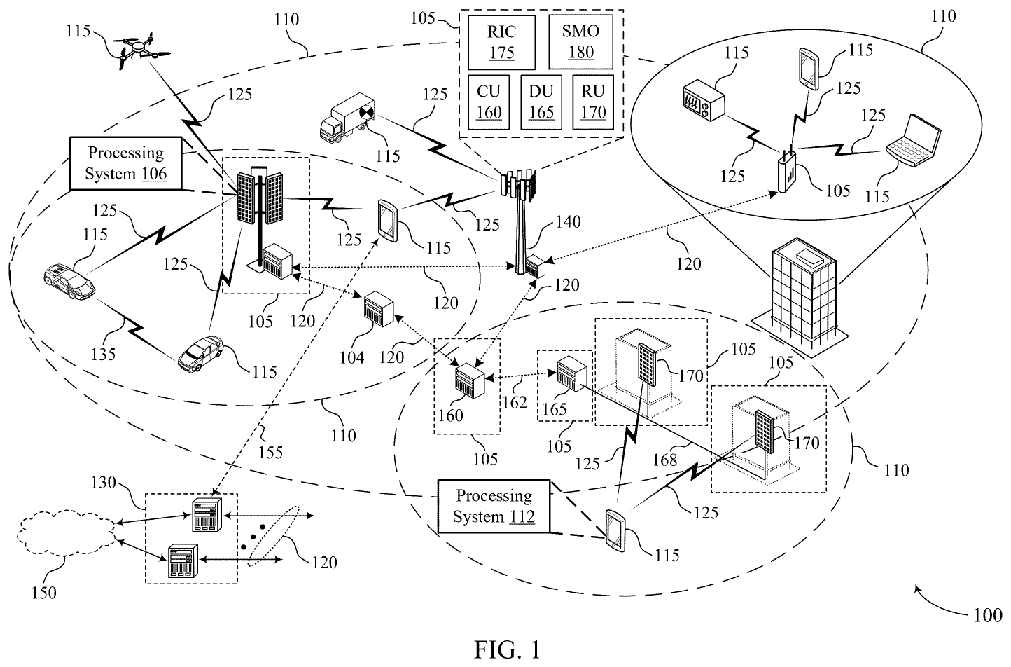

FIG. 1 shows an example of a wireless communications system 100 that supports available slot counting for hybrid automatic repeat request acknowledgement slot offset in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, a TDD system may support special slots, including symbol periods for uplink or downlink, or both. For example, a special slot in a TDD pattern may be utilized for uplink signaling or downlink signaling, or both. In some examples, a special slot may be referred to as a flexible slot.

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogenous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 115 may transmit HARQ feedback via an uplink control channel, such as a physical uplink control channel (PUCCH). For example, a network entity 105 may transmit downlink control information via a downlink control channel, such as a physical downlink control channel (PDCCH), to schedule the UE 115 to receive a downlink data information via a downlink shared channel, such as a physical downlink shared channel (PDSCH). The downlink control information may include resource allocation information for the PDSCH and indicate a slot offset to the PUCCH for the HARQ feedback.

In some examples, the downlink control information may include a parameter that indicates the slot offset to the PUCCH for the HARQ feedback. For example, a slot offset from a PDSCH slot to an uplink slot for HARQ feedback may be denoted by k₁. In some examples, the downlink control information may indicate a value for k₁. For example, one value of k₁ may be indicated by the downlink control information scheduling the PDSCH. In some cases, if there is only one k₁ value to indicate, the one k₁ value may be configured via RRC signaling (e.g., without indication in downlink control information). In some cases, RRC signaling may configure a set of possible k₁ values from which one k₁ value is indicated by the downlink control information. If the downlink control information does not schedule a PDSCH but triggers HARQ feedback, k₁ may correspond to a slot offset from a PDCCH slot carrying the downlink control information to the PUCCH slot for HARQ feedback.

A UE 115 may determine a codebook via semi-static information based on candidate PDSCH occasions. In some cases, the UE 115 may not consider PDCCH monitoring occasions for a Type 1 HARQ feedback codebook. The set of PDSCH occasions may be determine on a per-downlink serving cell basis. A set of configured K₁ values may correspond to possible slot timing offset values, or offsets between a PDSCH slot and a slot where the UE 115 transmits HARQ feedback. Downlink control information may indicate one slot timing offset value, k₁, from the set of slot timing offset values K₁. For each k₁ value, PDSCH time domain resource allocation (TDRA) candidates that overlap with semi-static uplink symbols may be removed from a set of PDSCH time domain resource allocation (TDRA) candidates corresponding to a start and length indicator value (SLIV) in a slot. The remaining TDRA candidates or row may be grouped such that a quantity of groups is a maximum quantity of non-overlapping SLIVs in the slot. For example, the UE 115 may first perform PDSCH occasion determination and second perform HARQ-ACK codebook determination based on the PDSCH occasions.

The parameter k₁ may be selected from a set of possible slot offset or k₁ values, which may be referred to as K₁. The set of slot offsets, K₁, may be configured via RRC signaling, such as in a parameter dl-DataToUL-Ack. A PDSCH to HARQ feedback timing indicator field in downlink control information may indicate the slot offset k₁ through ┌log₂|K₁|┐ bits. For fallback downlink control information, or downlink control information with a format 1_0, K₁ may include {1,2,3,4,5,6,7,8}, and three bits in downlink control information may indicate one of the eight values for k₁.

If a subcarrier spacing (SCS) of the PDSCH and the PUCCH cells are different, k₁ may be counted with respect to a numerology of the PUCCH cell. A reference slot to begin counting may be the last uplink slot (e.g., in the PUCCH cell) that overlaps with the downlink slot containing the PDSCH, or the PDCCH in case the downlink control information does not schedule PDSCH.

For a PUCCH cell in a time division duplex (TDD) system, a network entity 105 may schedule HARQ feedback in a next unused special or uplink slot which satisfies the PDSCH processing timeline. In a first example, a TDD pattern may be {D, D, D, S, U, D, D, D, S, U}, where D corresponds to a downlink slot, S corresponds to a special slot (e.g., including uplink symbols or downlink symbols, or both), and U corresponds to an uplink slot. Downlink control information in any of the first three downlink slots (e.g., slots 0 through 2) may indicate a slot offset pointing to the first uplink slot (e.g., slot 4) for HARQ feedback, and downlink control information in the first special slot or any of the later three downlink slots (e.g., slots 5 through 7) may indicate a slot offset pointing the second uplink slot (e.g., slot 9) for HARQ feedback. For example, downlink control information slot 0 and slot 5 may each indicate a k₁ of 4, downlink control information in slot 1 and slot 6 may each indicate a k₁ of 3, downlink control information in slot 2 and 7 may each indicate a k₁ of 2, and downlink control information in slot 3 may indicate a k₁ of 6. In this example, K₁ may include {6, 4, 3, 2}, and k₁ may be indicated by two bits in downlink control information.

In a second example, the TDD pattern may be {D, D, D, D, D, D, D, S, U, U}. In this example, downlink control information in each downlink slot (e.g., slots 0 through 6) may point to the first uplink slot (slot 8), and downlink control information in the special slot (slot 7) may point to the second uplink slot (slot 9). The set of slot offsets, K₁, for this TDD pattern may include {8, 7, 6, 5, 4, 3, 2}, and one of them (e.g., k₁) may be indicated using three bits in downlink control information.

In some examples, a UE 115 may be configured for a PUCCH cell switch. A PUCCH cell switch may reduce feedback latency. In some cases, a UE may only support PUCCH transmission on a primary cell in a PUCCH cell group. For uplink carrier aggregation with an offset TDD uplink/downlink pattern, using an earlier uplink or special slot on a secondary cell to transmit PUCCH signaling may reduce PUCCH feedback latency. For example, the UE 115 may be able to transmit HARQ feedback earlier by transmitting PUCCH signaling carrying the HARQ feedback on the secondary cell. Some systems support a PUCCH cell switch to transmit PUCCH on either the primary cell or a secondary cell, but not both simultaneously.

A network entity 105 may configure a UE 115 with a switch time pattern for PUCCH (e.g., cell switching pattern is not indicated dynamically by the scheduling downlink control information). The primary cell may be the reference cell by which the UE 115 interprets the time pattern. A k₁ value for feedback may be interpreted based on the primary cell. Type 1 HARQ codebook construction may be based on the K₁ sets of the primary cell. A PUCCH resource to transmit uplink control information, for example including HARQ feedback, may be interpreted based on PUCCH resources configured on the target PUCCH cell.

The wireless communications system 100, and wireless communications systems described herein, support techniques for indicating a slot offset to an uplink slot for HARQ feedback based on available uplink slots. For example, overhead for downlink control information may be reduced if a slot offset counts slots that are available for uplink transmission. In some examples, a slot may be an available uplink slot if the slot includes at least one uplink symbol or at least one flexible symbol. In some examples, a slot may be an available uplink slot if all symbols of the slot are uplink symbols or flexible symbols (or a combination of uplink symbols and flexible symbols). In some examples, a slot may be an available uplink slot if all symbols of the PUCCH resource (e.g., that carries HARQ feedback) in that slot are either uplink symbols or flexible symbols.

Criteria for an available uplink slot may be configurable. For example, a network entity 105 may configure a UE 115 to consider a slot as available for uplink transmission if the slot includes one or more uplink or flexible symbols. In some examples, a slot may be considered as available for uplink transmission based on whether the slot at least partially overlaps with an SSB transmission, such as in addition to other criteria. For example, a UE 115 may determine a slot is available for uplink transmission if the slot includes at least one uplink symbol or flexible symbol that does not overlap with SSB transmission, or the UE 115 may determine a slot is available for uplink transmission if it includes all uplink symbols or all flexible symbols, and none of the symbols of the slot overlap with SSB transmission.

Some additional techniques for constructing a HARQ feedback codebook are described. Additionally, techniques for slot offset counting based on available uplink slots with a semi-static cell switch configuration are described.

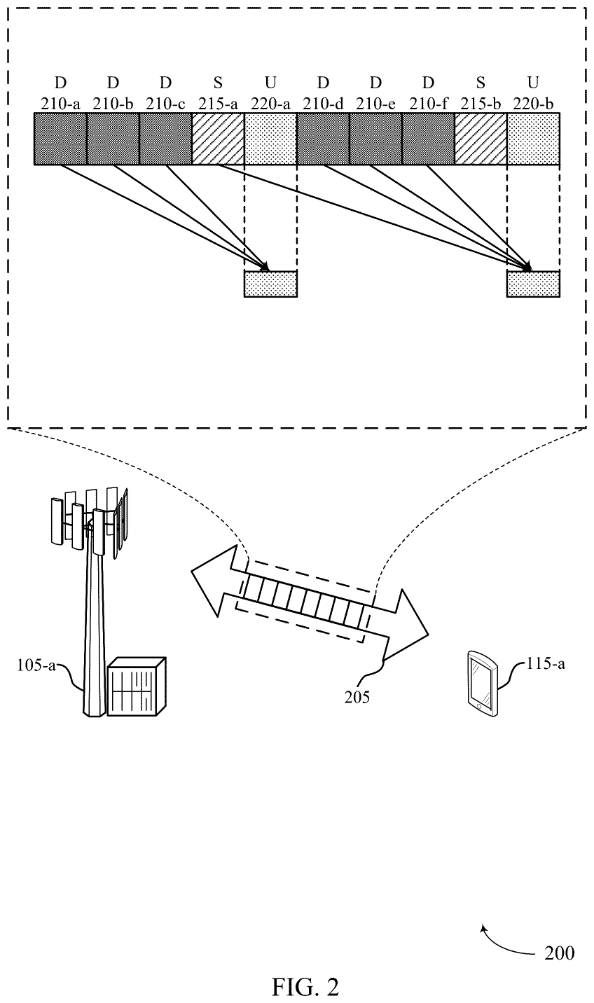

FIG. 2 shows an example of a wireless communications system 200 that supports available slot counting for hybrid automatic repeat request acknowledgement slot offset in accordance with one or more aspects of the present disclosure. The wireless communications system 200 may implement aspects of the wireless communications system 100. For example, the wireless communications system 200 may include a network entity 105-a and a UE 115-a, which may be respective examples of a network entity 105 and a UE 115 described herein.

The wireless communications system 200 may support TDD communications via a wireless communications link 205. The wireless communications link 205 may support one or more cells for downlink communications, such as a PDSCH cell, and one or more cells for uplink communications, such as a PUCCH cell. The network entity 105-a may transmit downlink signaling to the UE 115-a via the PDSCH cell over PDCCH channels, PDSCH channels, or both. The UE 115-a may transmit uplink signaling to the network entity 105-a via the PUCCH cell over PUCCH channels, PUSCH channels, or both.

In some examples, the network entity 105-a may configure a TDD pattern for a set of slots. The TDD pattern may indicate which slots of the set of slots are downlink slots 210, which slots are special slots 215, and which slots are uplink slots 220. The TDD pattern may be configured semi-statically, such as via RRC or MAC signaling.

The network entity 105-a may transmit downlink control information to the UE 115-a to schedule the UE 115-a to receive PDSCH signaling in one or more downlink slots 210 or special slots 215. In some examples, a downlink slot 210 may include PDCCH resources for the downlink control information. The downlink control information may indicate a slot offset to an uplink slot 220, and the UE 115-a may transmit feedback, such has HARQ feedback, for the PDSCH signaling over PUCCH resources of the uplink slot 220. For a PUCCH cell in a TDD system, the network entity 105-a may schedule HARQ feedback in a next available special or uplink slot, as long as a PDSCH processing timeline at the UE 115-a is satisfied.

The wireless communications system 200, and the devices therein, may support techniques to count available uplink slots for a slot offset to an uplink slot for HARQ feedback. To determine a slot for transmitting HARQ feedback on PUCCH corresponding to a given PDSCH, the slot offset between the PDSCH slot and the PUSCH slot may only count available slots for uplink transmission. For example, instead of indicating a slot offset that includes downlink slots or slots which otherwise cannot be used for uplink transmission (for example, due to the PDSCH processing timeline not being satisfied), the slot offset may correspond to, or count, slots which are available for uplink transmission. A slot offset which counts slots that are available for uplink transmission may be denoted by

$${k}_{1}^{′} .$$

A slot offset which counts all slots (for example, including downlink slots and slots that are not available for uplink transmission) may be denoted by k₁, as described with reference to FIG. 1.

For example, the TDD pattern may include a special slot 215-a, a special slot 215-b, an uplink slot 220-a, and an uplink slot 220-b may each be available for uplink transmission. If the UE 115-a is scheduled to receive PDSCH signaling during a downlink slot 210-a, a slot offset to an uplink slot 220 may be in terms of the slots that are available for uplink transmission. For example, the slot offset,

$${k}_{1}^{′} ,$$

for the downlink slot 210-a may have a value of ‘2’, counting the special slot 215-a and the uplink slot 220-a. The slot offset based on available uplink slots may not count a downlink slot 210-b or a downlink slot 210-c, as these downlink slots 210 may not be usable or available for uplink transmission. In comparison, a slot offset from the downlink slot 210-a which is based on all slots, k₁, may have a value of 4.

Overhead in downlink control information may be reduced based on there being fewer possible values of

$${k}_{1}^{′}$$

than k₁ in some scenarios. In this example of the TDD pattern for the PDSCH cell, a set of

$${k}_{1}^{′}$$

values,

$${K}_{1}^{′} ,$$

may include values of {2, 3}. For example, the downlink slot 210-a, the downlink slot 210-b, the downlink slot 210-c, a downlink slot 210-d, a downlink slot 210-e, and a downlink slot 210-f may each have a

$${k}_{1}^{′}$$

of 2, and the special slot 215-a may have a

$${k}_{1}^{′}$$

of 3. With a slot offset that is not based on available uplink slots, the set of K₁ may include values of {6, 4, 3, 2} as described with reference to FIG. 1. Downlink control information indicating

$${k}_{1}^{′}$$

may include one bit to indicate the slot offset based on available uplink slots, while downlink control information indicating k₁ may include two bits to indicate the slot offset based on all slots.

In some examples, a slot may be available for uplink transmission if the slot includes at least one uplink symbol or at least one flexible symbol. For example, a slot may be counted for

$${k}_{1}^{′}$$

if the slot includes at least one uplink or flexible symbols based on a TDD configuration, such as a semi-static TDD configuration or a TDD slot pattern. With this criteria for determining whether a slot is available for uplink transmission, each uplink slot (for example, including all uplink symbols) and each special slot (for example, including some downlink symbols, some flexible symbols, and some uplink symbols) may be counted toward the slot offset

$${k}_{1}^{′} ,$$

and downlink slots (for example, including all downlink symbols) are not counted. Additionally, or alternatively, a slot may be counted if the slot includes at least one uplink or flexible symbol which does not overlap with SSB transmission. For example, if all uplink symbols or all flexible symbols of a slot overlap with SSB transmission, that slot may not be counted toward the slot offset

$${k}_{1}^{′} .$$

According to this criteria, a slot may be counted as available for uplink transmission if the slot can accommodate a PUCCH resource (for example, of at least one symbol).

In some examples, a slot may be available for uplink transmission if all symbols of the slot are uplink symbols or flexible symbols. For example, a slot may be counted for

$${k}_{1}^{′}$$

if all symbols of the slot are uplink or flexible symbols based on a TDD configuration, such as a semi-static TDD configuration or a TDD slot pattern. With this criteria for determining whether a slot is available for uplink transmission, each uplink slot (for example, including all uplink symbols) is counted toward the slot offset

$${k}_{1}^{′} ,$$

but special slots including one or more downlink symbols and downlink slots (for example, including all downlink symbols) are not counted toward the slot offset

$${k}_{1}^{′} .$$

A flexible slot which only includes flexible symbols or uplink symbols (for example, and no downlink symbols) may count toward the slot offset

$${k}_{1}^{′} .$$

Additionally, or alternatively, a slot may be counted if the slot does not overlap with SSB transmission. For example, if any symbol of the slot overlaps with SSB transmission, that slot may not be counted toward the slot offset

$${k}_{1}^{′} .$$

According to this criteria, a but may be counted as available for uplink transmission if the slot can accommodate any PUCCH resource (for example, up to fourteen symbols for long PUCCH formats).

In some examples, a slot may be available for uplink transmission if all symbols of a PUCCH resource in the slot are either uplink symbols or flexible symbols. For example, a slot may be counted for

$${k}_{1}^{′}$$

if all symbols of the PUCCH resource in the slot are uplink or flexible symbols based on a TDD configuration, such as a semi-static TDD configuration or a TDD slot pattern. With this criteria for determining whether a slot is available for uplink transmission, whether a slot is counted toward the slot offset

$${k}_{1}^{′}$$

may be based on a payload for the HARQ feedback and a PUCCH resource indicator (PRI) in the downlink control information. Additionally, or alternatively, a slot may be counted if all symbols of the PUCCH resource in the slot are non-overlapping with SSB transmission. According to this criteria, a slot may be counted as available for uplink transmission if the slot can accommodate the PUCCH resource as indicated by downlink control information.

In some examples, any of these criteria for counting a slot as an available slot for uplink transmission may be based on uplink symbols instead of both uplink symbols and flexible symbols. For example, a slot may be counted as available for uplink transmission if it includes at least one uplink symbol, if it includes all uplink symbols, or if all symbols of a PUCCH resource in the slot are uplink symbols.

In some examples, the network entity 105-a may configure the UE 115-a with a criteria or a behavior for counting available uplink slots. The network entity 105-a may transmit control signaling, such as RRC signaling, to configure the UE 115-a to count slots that are available for uplink transmission according to one or more criteria described herein. For example, the control signaling may indicate that the UE 115-a is to count any slot which includes at least one uplink symbol or at least one flexible symbol as available for uplink transmission. Additionally, or alternatively, the control signaling may configure the UE 115-a to determine whether a slot is available for uplink transmission based on both uplink symbols and flexible symbols or just uplink symbols. For example, the network entity 105-a may configure the UE 115-a to determine whether a slot is available for uplink transmission based on uplink symbols (for example, and not flexible symbols) if flexible slots in a TDD pattern include many downlink symbols based on a PUCCH format or a quantity of symbols the network entity 105-a is to use for downlink signaling, which may be based on channel conditions.

In some examples, the network entity 105-a may configure a pattern associated with which slots should be counted as available slots for HARQ reporting. For example, the pattern may be indicated via a bitmap, with each bit of the bitmap corresponding to a slot of a frame. For example, with 30 kHz SCS, there may be 20 slots per frame, and the bitmap may be 20 bits long. A bit with a value of 1 may indicate that a slot corresponding to that bit is to be counted as available for uplink transmission, and a bit with a value of 0 may indicate that a slot corresponding to that bit is to be counted as unavailable for uplink transmission. The pattern may repeat across different frames, or the pattern may be the same for each frame until updated or disabled by the network entity 105-a. In addition to the bitmap that is applied for a given period, the configurations for the pattern may also include a periodicity (e.g., in terms of number of slots, subframes, frames) or an offset that determines the first slot of a given period. In this example, the available slot counting may not be tied to the TDD pattern, such that these techniques may also be implemented for FDD systems. In some examples, the network entity 105-a may configure different patterns of available slots for uplink transmission to different UEs 115, which may provide load balancing. For example, a first subset of slots in a first pattern configured at a first UE 115 may be indicated as available for uplink transmission, while a different, second subset of slots in a second pattern configured at a second UE 115 may be indicated as available for uplink transmission.

A set of slot offsets based on counting slots that are available for uplink transmission may be denoted by

$${K}_{1}^{′} .$$

In comparison, K₁ as described with reference to FIG. 1 may correspond to a set of slot offsets based on counting all slots (for example, including downlink slots or slots which are otherwise unavailable for uplink transmission). For some downlink control information formats, such as downlink control information format 1_1 and format 1_2, the set of slot offset

$${K}_{1}^{′}$$

may be configured by control signaling, such as RRC signaling. In some examples, the control signaling may indicate different sets of slot offsets

$${K}_{1}^{′}$$

for different downlink control information formats. A PDSCH-to-HARQ feedback timing indicator field in downlink control information may indicate a slot offset

$${k}_{1}^{′} ,$$

selected from

$${K}_{1}^{′} .$$

In some examples, the PDSCH-to-HARQ feedback timing indicator field may include ┌log₂|

$${K}_{1}^{′}$$

┐ bits.

If the set of slot offsets

$${K}_{1}^{′} .$$

includes only a single value, downlink control information may not include a PDSCH-to-HARQ feedback timing indicator field. For example, if

$${K}_{1}^{′}$$

only includes a single value for a single slot offset,

$${k}_{1}^{′} ,$$

downlink control information which schedules a PDSCH may not include an indication of

$${k}_{1}^{′} .$$

For example, the slot offset based on available slots for uplink transmission may be implicitly indicated, or determined by the UE 115-a, based on there being a single

$${k}_{1}^{′}$$

value in

$${K}_{1}^{′} .$$

For some downlink control information formats, the set of slot offsets

$${K}_{1}^{′}$$

may be preconfigured for the wireless communications system 200. For example, for fallback downlink control information, or downlink control information with format 1_0, the set of

$${K}_{1}^{′}$$

may be preconfigured. For example, if fallback downlink control information includes one bit for a PDSCH-to-HARQ feedback indicator,

$${K}_{1}^{′}$$

may include values of {1, 2}. If fallback downlink control information includes two bits for a PDSCH-to-HARQ feedback indicator,

$${K}_{1}^{′}$$

may include values of {1, 2, 3, 4}.

A HARQ-ACK codebook may be determined based on semi-static information, such as candidate PDSCH occasions. In some cases, a UE 115 may not consider PDCCH monitoring occasions for some HARQ-ACK codebooks, such as a Type 1 HARQ-ACK codebook. The set of PDSCH occasions may be determined per-downlink serving cell or a on downlink serving cell basis. A set of configured K₁ values may include a set of possible timing offset values (e.g., offsets between a PDSCH slot and a corresponding slot for HARQ-ACK feedback) and may be indicated by downlink control information, such as the downlink control information scheduling the PDSCH slot. If downlink control information Format 1_1 is configured for the downlink serving cell, and downlink control information Format 1_2 is not configured for the downlink serving cell, K₁ may include, for example, k values of {1, 2, 3, 4, 5, 6, 7, 8}. If downlink control information Format 1_1 and 1_2 are configured for the downlink serving cell, K₁ may be indicated via a parameter in higher layer signaling, such as parameter ‘dl-DataToUL-ACK’ in RRC signaling.

The wireless communications system 200 supports techniques that provide a correspondence between

$${K}_{1}^{′}$$

and K₁. If the UE 115-a is configured with a Type 1 HARQ-ACK codebook, the HARQ-ACK codebook construction for PUCCH in slot n may consider all PDSCH slots within k₁ slots of slot n. For example, the PUCCH in slot n may consider PDSCH slots within n−k₁ slots of the PUCCH slot, such that the slot offset based on available slot counting

$$( {k}_{1}^{′} )$$

is a member of

$${K}_{1}^{′} .$$

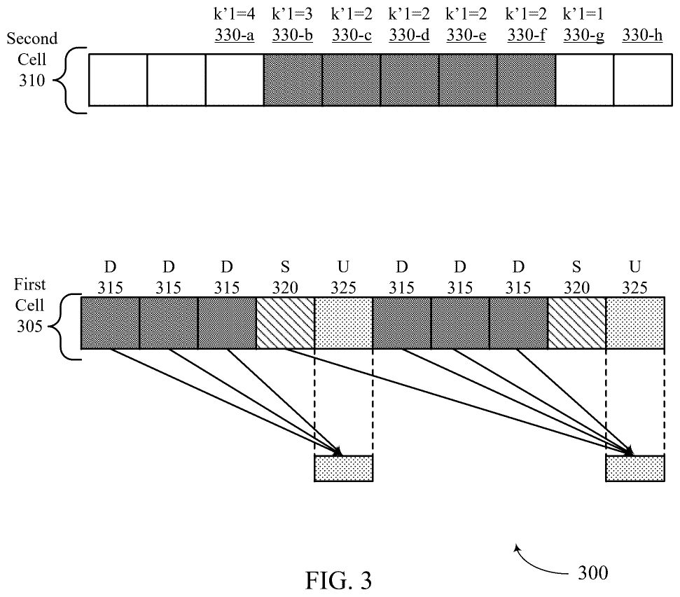

An example of HARQ-ACK codebook construction is described in more detail with reference to FIG. 3.

In some examples, the UE 115-a may be configured for a PUCCH cell switch between a primary cell and a secondary cell as described with reference to FIG. 1. If the UE 115-a is configured for a PUCCH cell switch and a semi-static cell switch pattern, the UE 115-a may count slots on the primary cell for a slot offset

$${k}_{1}^{′}$$

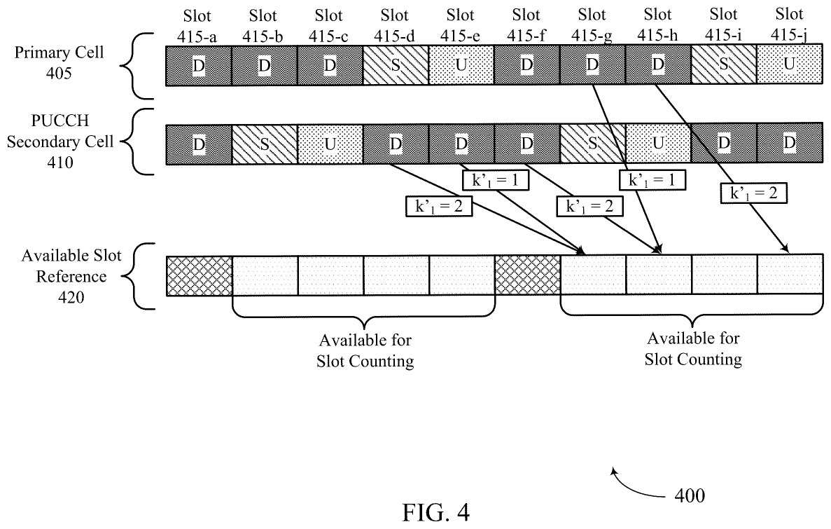

by consider a slot in the primary cell as available if it is available on either the primary cell or overlaps with an available slot on the secondary cell. An example of slot counting when a UE 115 is configured for a PUCCH cell switch is described in more detail with reference to FIG. 4.

FIG. 3 shows an example of a feedback codebook construction 300 that supports available slot counting for hybrid automatic repeat request acknowledgement slot offset in accordance with one or more aspects of the present disclosure. The feedback codebook construction may implement aspects of a wireless communications system 100 or a wireless communications system 200 described herein. For example, the feedback codebook construction 300 may be based on counting slots between a PDSCH slot and a PUCCH slot carrying HARQ-ACK feedback for the PDSCH slot based on available slots, or slots which are available for uplink transmission.

A UE 115 may be configured with a first cell 305. The first cell 305 may be an example of a primary cell or a PUCCH cell. The first cell 305 may be configured to include one or more downlink slots 210, one or more special slots 215, or one or more uplink slots 220, or any combination thereof. In some examples, the UE 115 may be configured with a second cell 310. The second cell 310 may be an example of a secondary cell or a PDSCH cell. The second cell 310 may include downlink slots 210.

The UE 115 may transmit receive data information via a PDSCH and transmit feedback for the data information via PUCCH. A slot including the PUCCH may be offset from the PDSCH according to a slot offset,

$${k}_{1}^{′} ,$$

that counts slots that are available for uplink transmission. Different criteria for whether a slot is available for uplink transmission is described in more detail with reference to FIG. 2. The slot offset

$${k}_{1}^{′}$$

may be included in a set of slot offset,

$${K}_{1}^{′} ,$$

which includes one or more slot offsets that are based on slots that are available for uplink transmission.

The UE 115 may construct a feedback codebook, or a HARQ-ACK codebook, for the feedback information transmitted via the PUCCH. In some cases, the codebook may be determined via semi-static information based on candidate PDSCH occasions. The UE 115 may determine PDSCH occasions, or candidate PDSCH occasions, and determine the HAQ-ACK codebook based on the PDSCH occasions. The set of candidate PDSCH occasions may be determine on a per-downlink serving cell basis.

A set of slot offsets, K₁, may be configured at the UE 115, such as through RRC signaling. The set of slot offsets K₁ may correspond to all slots between the PDSCH and HARQ-ACK, or a slot used to transmit the data information and a corresponding uplink slot used to transmit feedback for the data information. For each K₁ value, TDRA candidates that overlap with semi-static uplink symbols may be removed from the set of PDSCH TDRA candidates, corresponding to a SLIV within a slot. The remaining TDRA row may be grouped such that a quantity of groups is a maximum quantity of non-overlapping SLIVs within the slot.

The feedback codebook construction 300 provides an example to correspond K₁ and

$${K}_{1}^{′}$$

as described herein. For example, when a UE 115 is configured with a Type 1 HARQ-ACK codebook, HARQ-ACK codebook construction for a PUCCH in slot n may consider all PDSCH slots within k₁ slots from slot n. For example, a window of possible slots that the UE 115 can provide feedback for from slot n may be the k₁ previous slots. This way, the slot offset based on available slot counting

$${k}_{1}^{′} ,$$

is a member of

$${K}_{1}^{′} .$$

The feedback codebook construction 300 shows an example of constructing a HARQ-ACK codebook for the first cell 305 and the second cell 310. In the example of the feedback codebook construction 300,

$${K}_{1}^{′}$$

may include slot offsets of {2, 3}. For a PUCCH on uplink slot 325 of the first cell 305, any uplink slot 325 which is offset from the uplink slot 325 by a quantity of available slots within

$${K}_{1}^{′}$$

may be included in the HARQ-ACK codebook.

For example, there may be three available slots in the first cell 305 (for example, the uplink slot 325, the special slot 320, and the uplink slot 325). Since three is included within the set of

$${K}_{1}^{′} ,$$

a slot on the second cell 310 corresponding the slot 330-b may be a PDSCH occasion candidate and included in the HARQ-ACK codebook. Slots corresponding to a slot 330-c, a slot 330-d, and a slot 330-e on the second cell 310 may each have two available slots between the respective slots 330 and the slot 330-h, therefore also being included in the HARQ-ACK codebook. A slot 330-a on the second cell 310 may have four available slots between the slot 330-a and the slot 330-h, and a slot 330-f on the second cell 310 may have one available slot between the slot 330-f and the slot 330-h, so the slot 330-a and the slot 330-h may not be included in the HAQ-ACK codebook, as available slot offsets of four and one are not included in the set of

$${K}_{1}^{′} .$$

FIG. 4 shows an example of a cell switch procedure 400 that supports available slot counting for hybrid automatic repeat request acknowledgement slot offset in accordance with one or more aspects of the present disclosure. The cell switch procedure may implement aspects of a wireless communications system 100 or 200 and a feedback codebook construction 300 as described with reference to FIGS. 1, 2, and 3, respectively.

A UE 115 may be configured with a primary cell 405 and a PUCCH secondary cell 410. The primary cell 405 and the PUCCH secondary cell 410 may each be configured with uplink slots, downlink slots, special slots, or any combination thereof. In some examples, the primary cell 405 and the PUCCH secondary cell 410 may have different TDD slot patterns, as shown.

The UE 115 may be configured for a PUCCH cell switch. A PUCCH cell switch may reduce feedback latency, as the UE 115 may use uplink resources on either a primary cell 405 or a PUCCH secondary cell 410 to transmit feedback for data information. For example, the UE 115 may transmit HARQ feedback earlier by transmitting PUCCH signaling carrying the HARQ feedback on the PUCCH secondary cell 410. In some systems, if a PUCCH cell switch is not configured, the UE 115 may only support PUCCH transmission on a primary cell in a PUCCH cell group. For uplink carrier aggregation with an offset TDD uplink/downlink pattern, using an earlier uplink or special slot on a secondary cell to transmit PUCCH signaling may reduce PUCCH feedback latency. Some systems support a PUCCH cell switch to transmit PUCCH on either the primary cell or a secondary cell, but not both simultaneously.

A network entity 105 may configure a UE 115 with a switch time pattern for PUCCH (e.g., cell switching pattern is not indicated dynamically by the scheduling downlink control information). The primary cell 405 may be the reference cell by which the UE 115 interprets the time pattern. A K₁ value for feedback may be interpreted based on the primary cell 405. Type 1 HARQ codebook construction may be based on the k₁ sets of the primary cell. A PUCCH resource to transmit uplink control information, for example including HARQ feedback, may be interpreted based on PUCCH resources configured on the target PUCCH cell.

When a UE 115 is configured for a PUCCH cell switch and a semi-static cell switch pattern, a slot may be considered available for uplink transmission if the slot is either available on the primary cell 405 or overlaps with an available slot on the PUCCH secondary cell 410. For example, available slot reference 420 shows which slots are counted toward a slot offset on the primary cell 405. For example, a slot 415-d, a slot 415-c, a slot 415-i, and a slot 415-j may each meet criteria to be considered available for uplink transmission on the primary cell 405. A slot 415-b, a slot 415-c, a slot 415-g, and a slot 415-h may each not meet the criteria to be considered available for uplink transmission on the primary cell 405, but these slots may meet the criteria to be considered available for uplink transmission on the PUCCH secondary cell 410. Thus, the slot 415-b, the slot 415-c, the slot 415-g, and the slot 415-h may each count toward the slot offset on the primary cell 405, as the UE 115 may be able to use these slots to transmit the feedback using the PUCCH secondary cell 410. A slot 415-a and a slot 415-f may each correspond to downlink slots on the primary cell 405 and the PUCCH secondary cell 410 and not be considered as available for uplink transmission on either cell, so the slot 415-a and the slot 415-f may not count toward the slot offset for the primary cell 405.

In some examples, the UE 115 may transmit the feedback information via PUCCH transmission on either the primary cell 405 or the PUCCH secondary cell 410 based on the TDD slot patterns. For example, if the UE 115 receives data information during the slot 415-g, the UE 115 may transmit feedback information during slot 415-h on the PUCCH secondary cell 410 based on indicating.

$${k}_{1}^{′} = 1$$

according to available slot counting by considering the available slot reference 420 as discussed above. If the UE 115 receives data information during the slot 415-h, the UE 115 may transmit feedback information during slot 415-i on the primary cell 405 based on indicating

$${k}_{1}^{′} = 2$$

according to available slot counting by considering the available slot reference 420 as discussed above. PUCCH transmission on the primary cell 405 or the PUCCH secondary cell 410 may be based on an RRC-configured pattern after slot availability is determined based on available slots of the primary cell 405, the PUCCH secondary cell 410, or both.

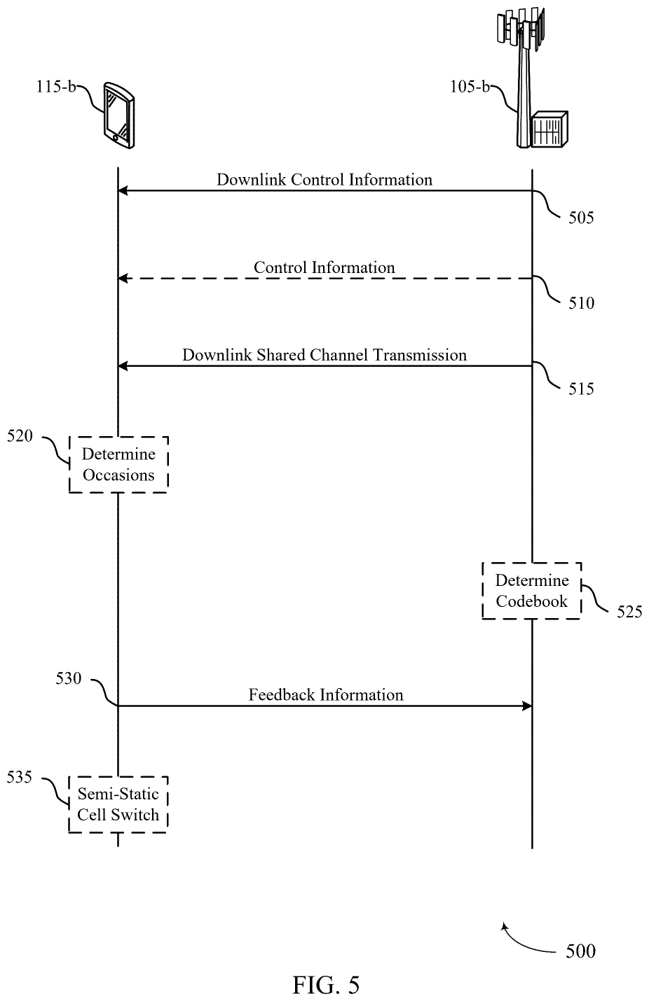

FIG. 5 shows an example of a process flow 500 that supports available slot counting for hybrid automatic repeat request acknowledgement slot offset in accordance with one or more aspects of the present disclosure. The process flow 500 includes a UE 115-b and a network entity 105-b which may be examples of the corresponding devices as described with respect to FIGS. 1-4. In the following description of the process flow 500, the operations between the UE 115-b and the network entity 105-b may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 115-b may receive downlink control information that schedules a downlink shared channel transmission. The downlink control information may indicate a slot offset between the downlink shared channel transmission and an uplink channel transmission occasion. The slot offset may correspond to a quantity of one or more available slots for uplink transmission. In some cases, the downlink control information may indicate the slot offset. In some examples, each respective slot of the quantity of one or more available slots for uplink transmission may include a respective set of symbols including at least one of one or more uplink symbols or one or more flexible symbols. Additionally, or alternatively, each respective slot of the quantity of one or more available slots for uplink transmission may include a respective set of one or more symbols that does not overlap with a synchronization signal block, and each respective set of one or more symbols may include at least one of one or more uplink symbols or one or more flexible symbols.

In some implementations, each respective slot of the quantity of one or more available slots for uplink transmission may exclusively include uplink symbols, flexible symbols, or a combination thereof. For example, each respective slot of the quantity of one or more available slots for uplink transmission may include only uplink symbols, only flexible symbols, or both. In some examples, each respective slot of the quantity of one or more available slots may be non-overlapping with a synchronization signal block. Each slot of the quantity of one or more available slots for uplink transmission may exclusively include a quantity of uplink symbols, flexible symbols, or a combination thereof, that corresponds to the uplink channel transmission occasion. For example, each slot of the quantity of one or more available slots may include a quantity of only uplink symbols, only flexible symbols, or both, that corresponds to the uplink channel transmission occasion. In any case, each respective slot of the quantity of one or more available slots may be non-overlapping with a synchronization signal block. In some examples, each slot of the quantity of one or more available slots for uplink transmission may exclude downlink symbols or may not exclusively include downlink symbols. For example, each slot of the quantity may only include downlink symbols, or may not only include downlink symbols.

At 510, the UE 115-b may receive control information that indicates a pattern. The quantity of one or more available slots for uplink transmission may be based on the pattern. The control information may indicate a set of one or more slot offsets associated with the quantity of one or more available slots for uplink transmission. The slot offset (e.g., indicated at 505) may be from the set of one or more slot offsets. In some implementations, the control information and the downlink control information may include same signaling (e.g., the downlink control information may indicate the pattern, the set of one or more slot offsets, and so on).

At 515, the UE 115-b may receive the downlink shared channel transmission based on the downlink control information. At 520, the UE 115-b may determine a set of one or more downlink channel transmission occasions for a feedback codebook based on a set of differences between each slot index of a set of slot indexes and the slot offset. In some examples, the set of slot indexes may correspond to the set of one or more downlink channel transmission occasions. At 525, the network entity 105-b may determine a feedback codebook of feedback information for a set of downlink channel transmission occasions based on a set of differences between each slot index of a set of slot indexes and the slot offset. The set of slot indexes corresponds to the set of downlink channel transmission occasions.

At 530, the UE 115-b may transmit the feedback information during the uplink channel transmission occasion based on the slot offset. For example, the UE 115-b may transmit the feedback information at a slot within the uplink channel transmission occasion using the slot offset. A slot offset may indicate a quantity of slots between a first feedback information slot and a second feedback information slot. In some implementations, the slot offset may indicate a quantity of slots between the two feedback information slots, plus one. FIGS. 3 and 4 provide further details regarding how a UE 115 may use slot offsets to determine slots for transmitting feedback information. Thus, the UE 115-b may determine a slot in which to transmit the feedback information based on the slot offset.

At 535, the UE 115-b may perform, based on the control information, a semi-static cell switch between a primary cell and a secondary cell. Similarly, the network entity 105-b may perform, based on the control information, the semi-static cell switch (e.g., for the UE 115-b) between the primary cell and the secondary cell. In some examples, the quantity of one or more available slots for uplink transmission comprises available slots on at least one of the primary cell or the secondary cell.

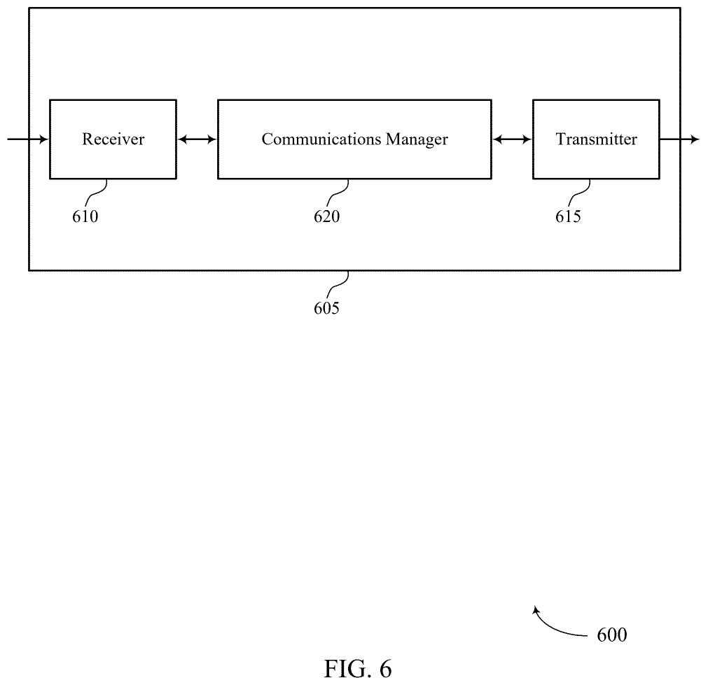

FIG. 6 shows a block diagram 600 of a device 605 that supports available slot counting for hybrid automatic repeat request acknowledgement slot offset in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to available slot counting for hybrid automatic repeat request acknowledgement slot offset). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to available slot counting for hybrid automatic repeat request acknowledgement slot offset). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of available slot counting for hybrid automatic repeat request acknowledgement slot offset as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The communications manager 620 is capable of, configured to, or operable to support a means for receiving, based on the downlink control information, the downlink shared channel transmission. The communications manager 620 is capable of, configured to, or operable to support a means for transmitting feedback information during the uplink channel transmission occasion based on the slot offset.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for available slot counting for hybrid automatic repeat request acknowledgement slot offset, which may result in reduced processing, reduced signaling overhead, and more efficient utilization of communication resources, among other advantages.

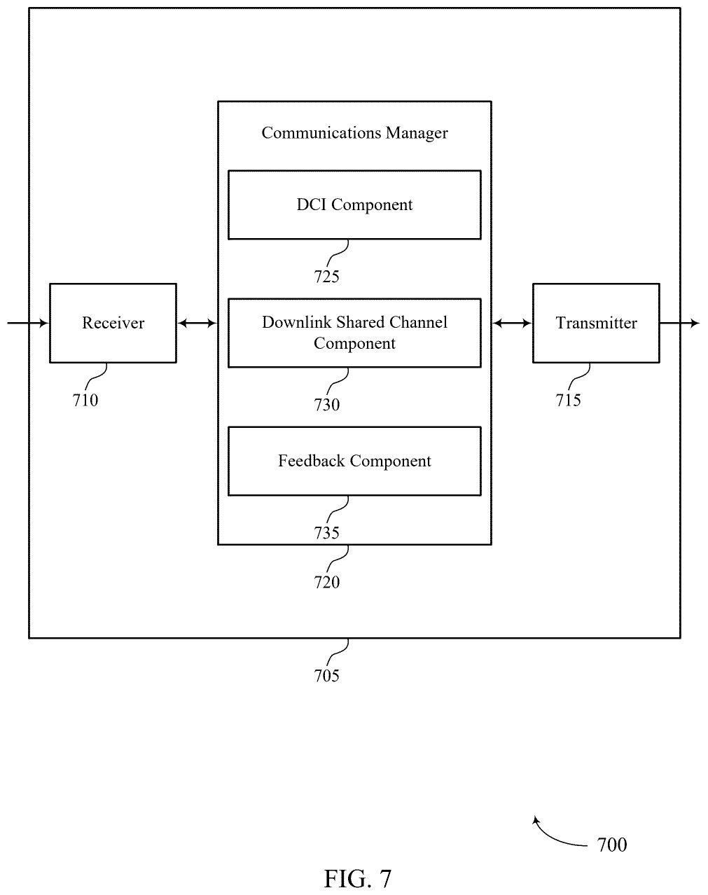

FIG. 7 shows a block diagram 700 of a device 705 that supports available slot counting for hybrid automatic repeat request acknowledgement slot offset in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to available slot counting for hybrid automatic repeat request acknowledgement slot offset). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to available slot counting for hybrid automatic repeat request acknowledgement slot offset). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of available slot counting for hybrid automatic repeat request acknowledgement slot offset as described herein. For example, the communications manager 720 may include a downlink control information component 725, a downlink shared channel component 730, a feedback component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The downlink control information component 725 is capable of, configured to, or operable to support a means for receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The downlink shared channel component 730 is capable of, configured to, or operable to support a means for receiving, based on the downlink control information, the downlink shared channel transmission. The feedback component 735 is capable of, configured to, or operable to support a means for transmitting feedback information during the uplink channel transmission occasion based on the slot offset.

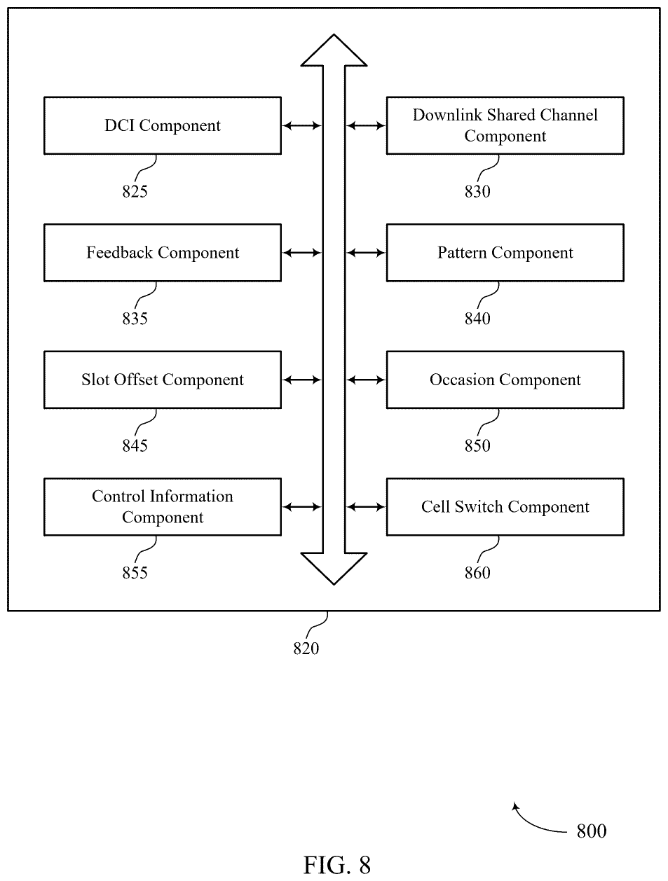

FIG. 8 shows a block diagram 800 of a communications manager 820 that supports available slot counting for hybrid automatic repeat request acknowledgement slot offset in accordance with one or more aspects of the present disclosure. The communications manager 820 may be an example of aspects of a communications manager 620, a communications manager 720, or both, as described herein. The communications manager 820, or various components thereof, may be an example of means for performing various aspects of available slot counting for hybrid automatic repeat request acknowledgement slot offset as described herein. For example, the communications manager 820 may include a downlink control information component 825, a downlink shared channel component 830, a feedback component 835, a pattern component 840, a slot offset component 845, an occasion component 850, a control information component 855, a cell switch component 860, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The downlink control information component 825 is capable of, configured to, or operable to support a means for receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The downlink shared channel component 830 is capable of, configured to, or operable to support a means for receiving, based on the downlink control information, the downlink shared channel transmission. The feedback component 835 is capable of, configured to, or operable to support a means for transmitting feedback information during the uplink channel transmission occasion based on the slot offset.

In some examples, the downlink control information indicates the slot offset.

In some examples, each respective slot of the quantity of one or more available slots for uplink transmission includes a respective set of multiple symbols including at least one of one or more uplink symbols or one or more flexible symbols.

In some examples, each respective slot of the quantity of one or more available slots for uplink transmission includes a respective set of one or more symbols that does not overlap with a synchronization signal block. In some examples, each respective set of one or more symbols includes at least one of one or more uplink symbols or one or more flexible symbols.

In some examples, each respective slot of the quantity of one or more available slots for uplink transmission exclusively includes uplink symbols, flexible symbols, or a combination thereof.

In some examples, each respective slot of the quantity of one or more available slots is non-overlapping with a synchronization signal block.

In some examples, each slot of the quantity of one or more available slots for uplink transmission exclusively includes a quantity of uplink symbols, flexible symbols, or a combination thereof, that corresponds to the uplink channel transmission occasion.

In some examples, each respective slot of the quantity of one or more available slots is non-overlapping with a synchronization signal block.

In some examples, each slot of the quantity of one or more available slots for uplink transmission excludes downlink symbols or does not exclusively include downlink symbols.

In some examples, the pattern component 840 is capable of, configured to, or operable to support a means for receiving control information that indicates a pattern, where the quantity of one or more available slots for uplink transmission is based on the pattern.

In some examples, the slot offset component 845 is capable of, configured to, or operable to support a means for receiving control information that indicates a set of one or more slot offsets associated with the quantity of one or more available slots for uplink transmission, where the slot offset is from the set of one or more slot offsets.

In some examples, the occasion component 850 is capable of, configured to, or operable to support a means for determining a set of one or more downlink channel transmission occasions for a feedback codebook based on a set of differences between each slot index of a set of slot indexes and the slot offset, where the set of slot indexes corresponds to the set of one or more downlink channel transmission occasions.

In some examples, the control information component 855 is capable of, configured to, or operable to support a means for receiving control information. In some examples, the cell switch component 860 is capable of, configured to, or operable to support a means for performing, based on the control information, a semi-static cell switch between a primary cell and a secondary cell, where the quantity of one or more available slots for uplink transmission includes available slots on at least one of the primary cell or the secondary cell.

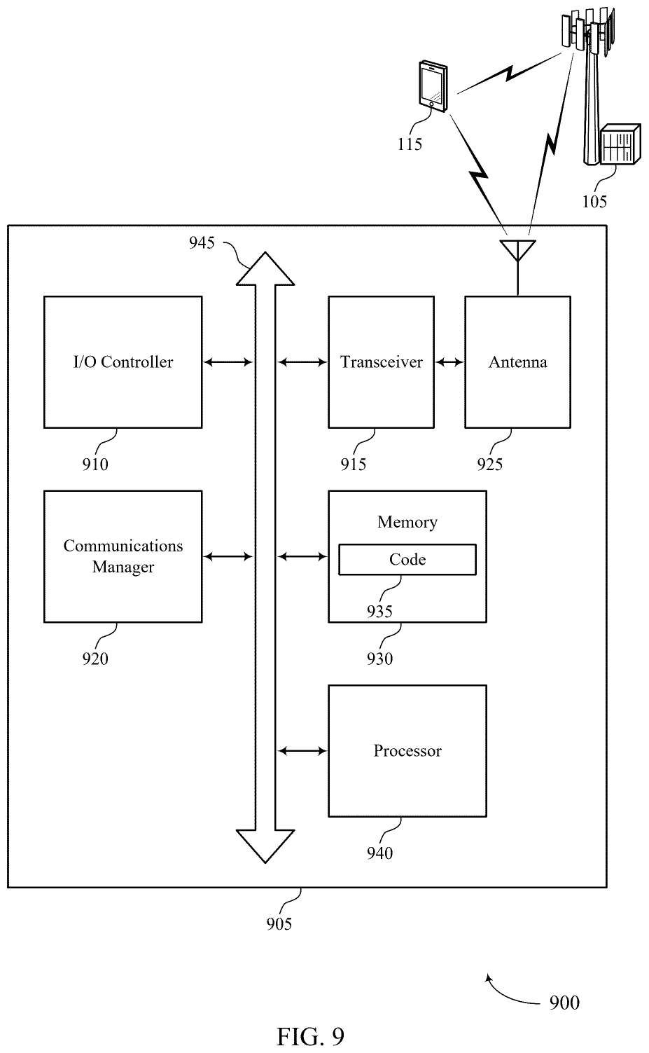

FIG. 9 shows a diagram of a system 900 including a device 905 that supports available slot counting for hybrid automatic repeat request acknowledgement slot offset in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting available slot counting for hybrid automatic repeat request acknowledgement slot offset). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The communications manager 920 is capable of, configured to, or operable to support a means for receiving, based on the downlink control information, the downlink shared channel transmission. The communications manager 920 is capable of, configured to, or operable to support a means for transmitting feedback information during the uplink channel transmission occasion based on the slot offset.

By including or configuring the communications manager 920 in accordance with examples as described herein, the device 905 may support techniques for available slot counting for hybrid automatic repeat request acknowledgement slot offset, which may result in improved communication reliability, improved user experience related to reduced processing, reduced signaling overhead, more efficient utilization of communication resources, improved coordination between devices, longer battery life, and improved utilization of processing capability among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of available slot counting for hybrid automatic repeat request acknowledgement slot offset as described herein, or the at least one processor 940 and the at least one memory 930 may be otherwise configured to, individually or collectively, perform or support such operations.

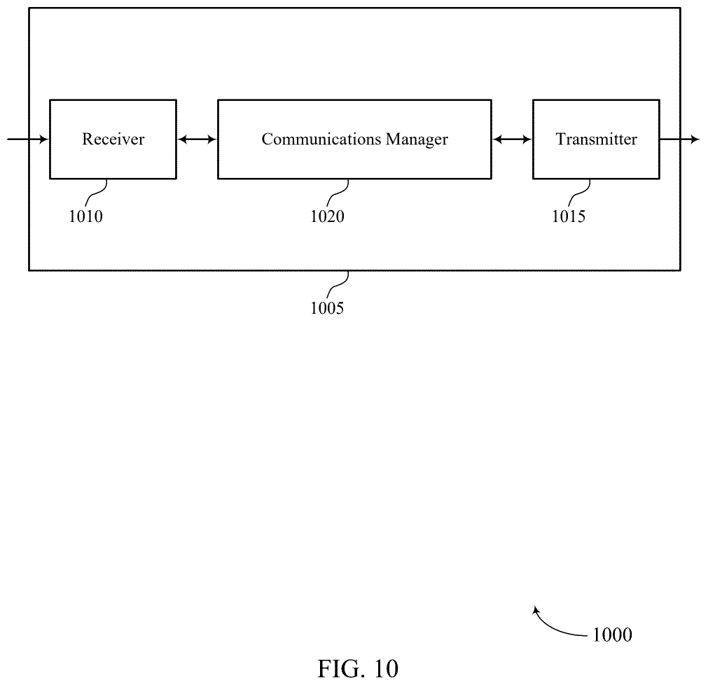

FIG. 10 shows a block diagram 1000 of a device 1005 that supports available slot counting for hybrid automatic repeat request acknowledgement slot offset in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of available slot counting for hybrid automatic repeat request acknowledgement slot offset as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The communications manager 1020 is capable of, configured to, or operable to support a means for outputting, based on the downlink control information, the downlink shared channel transmission. The communications manager 1020 is capable of, configured to, or operable to support a means for obtaining feedback information during the uplink channel transmission occasion based on the slot offset.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for available slot counting for hybrid automatic repeat request acknowledgement slot offset, which may result in reduced processing, reduced signaling overhead, and more efficient utilization of communication resources, among other advantages.

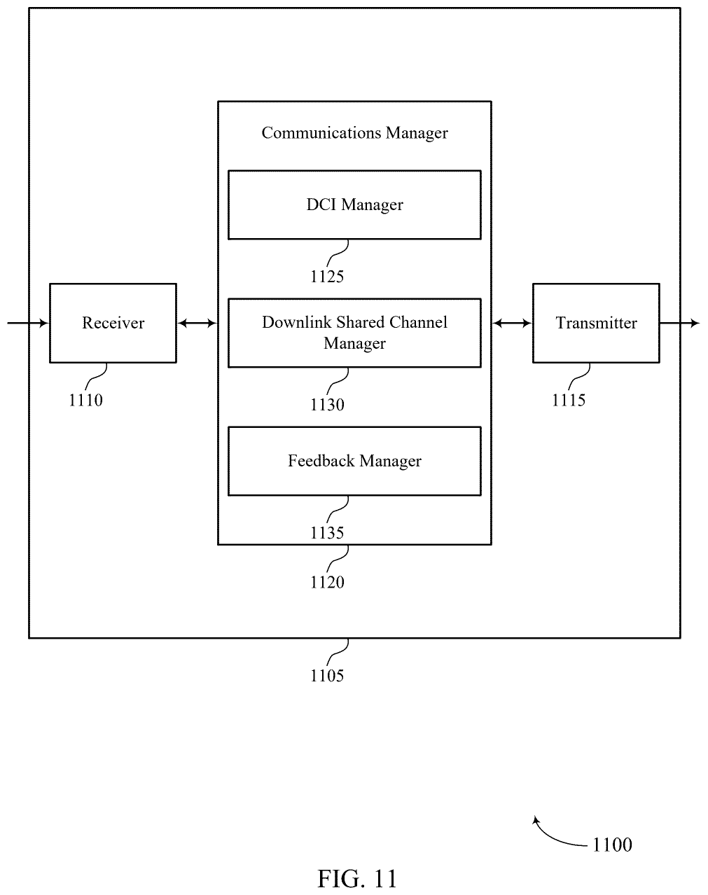

FIG. 11 shows a block diagram 1100 of a device 1105 that supports available slot counting for hybrid automatic repeat request acknowledgement slot offset in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of available slot counting for hybrid automatic repeat request acknowledgement slot offset as described herein. For example, the communications manager 1120 may include a downlink control information manager 1125, a downlink shared channel manager 1130, a feedback manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The downlink control information manager 1125 is capable of, configured to, or operable to support a means for outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The downlink shared channel manager 1130 is capable of, configured to, or operable to support a means for outputting, based on the downlink control information, the downlink shared channel transmission. The feedback manager 1135 is capable of, configured to, or operable to support a means for obtaining feedback information during the uplink channel transmission occasion based on the slot offset.

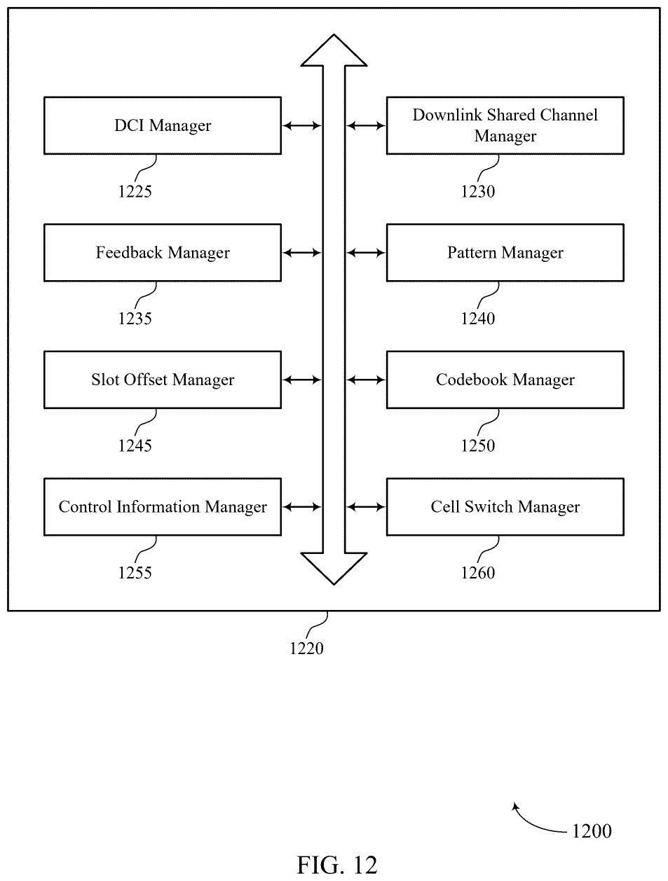

FIG. 12 shows a block diagram 1200 of a communications manager 1220 that supports available slot counting for hybrid automatic repeat request acknowledgement slot offset in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of available slot counting for hybrid automatic repeat request acknowledgement slot offset as described herein. For example, the communications manager 1220 may include a downlink control information manager 1225, a downlink shared channel manager 1230, a feedback manager 1235, a pattern manager 1240, a slot offset manager 1245, a codebook manager 1250, a control information manager 1255, a cell switch manager 1260, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The downlink control information manager 1225 is capable of, configured to, or operable to support a means for outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The downlink shared channel manager 1230 is capable of, configured to, or operable to support a means for outputting, based on the downlink control information, the downlink shared channel transmission. The feedback manager 1235 is capable of, configured to, or operable to support a means for obtaining feedback information during the uplink channel transmission occasion based on the slot offset. In some examples, the downlink control information indicates the slot offset.

In some examples, each respective slot of the quantity of one or more available slots for uplink transmission includes a respective set of multiple symbols including at least one of one or more uplink symbols or one or more flexible symbols.

In some examples, each respective slot of the quantity of one or more available slots for uplink transmission includes a respective set of one or more symbols with a synchronization signal block. In some examples, each respective set of one or more symbols includes at least one of one or more uplink symbols or one or more flexible symbols.

In some examples, each respective slot of the quantity of one or more available slots for uplink transmission exclusively includes uplink symbols flexible symbols, or a combination thereof.

In some examples, each respective slot of the quantity of one or more available slots is non-overlapping with a synchronization signal block.

In some examples, each slot of the quantity of one or more available slots for uplink transmission exclusively includes a quantity of uplink symbols, flexible symbols, or a combination thereof, that corresponds to the uplink channel transmission occasion.

In some examples, each respective slot of the quantity of one or more available slots is non-overlapping with a synchronization signal block.

In some examples, each slot of the quantity of one or more available slots for uplink transmission excludes downlink symbols or does not exclusively include downlink symbols.

In some examples, the pattern manager 1240 is capable of, configured to, or operable to support a means for outputting control information that indicates a pattern, where the quantity of one or more available slots for uplink transmission is based on the pattern.

In some examples, the slot offset manager 1245 is capable of, configured to, or operable to support a means for outputting control information that indicates a set of one or more slot offsets associated with the quantity of one or more available slots for uplink transmission, where the slot offset is from the set of one or more slot offsets.

In some examples, the codebook manager 1250 is capable of, configured to, or operable to support a means for determining a feedback codebook of the feedback information for a set of downlink channel transmission occasions based on a set of differences between each slot index of a set of slot indexes and the slot offset, where the set of slot indexes corresponds to the set of downlink channel transmission occasions.

In some examples, the control information manager 1255 is capable of, configured to, or operable to support a means for outputting control information. In some examples, the cell switch manager 1260 is capable of, configured to, or operable to support a means for performing, based on the control information, a semi-static cell switch between a primary cell and a secondary cell, where the quantity of one or more available slots for uplink transmission includes available slots on at least one of the primary cell or the secondary cell.

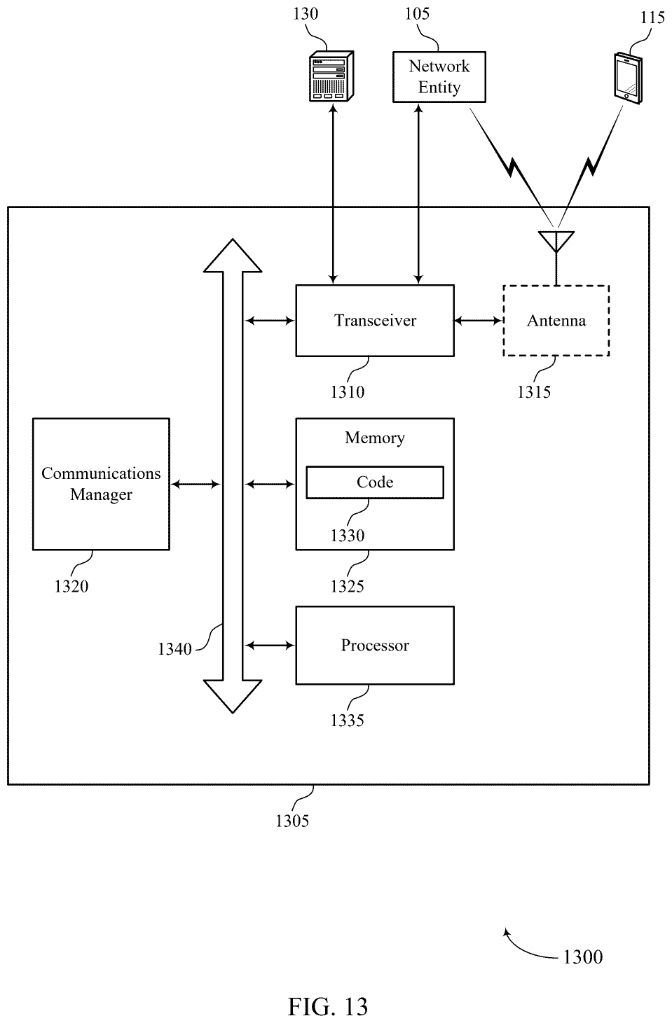

FIG. 13 shows a diagram of a system 1300 including a device 1305 that supports available slot counting for hybrid automatic repeat request acknowledgement slot offset in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting available slot counting for hybrid automatic repeat request acknowledgement slot offset). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The communications manager 1320 is capable of, configured to, or operable to support a means for outputting, based on the downlink control information, the downlink shared channel transmission. The communications manager 1320 is capable of, configured to, or operable to support a means for obtaining feedback information during the uplink channel transmission occasion based on the slot offset.

By including or configuring the communications manager 1320 in accordance with examples as described herein, the device 1305 may support techniques for available slot counting for hybrid automatic repeat request acknowledgement slot offset, which may result in improved communication reliability, improved user experience related to reduced processing, reduced signaling overhead, more efficient utilization of communication resources, improved coordination between devices, longer battery life, and improved utilization of processing capability among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of available slot counting for hybrid automatic repeat request acknowledgement slot offset as described herein, or the at least one processor 1335 and the at least one memory 1325 may be otherwise configured to, individually or collectively, perform or support such operations.

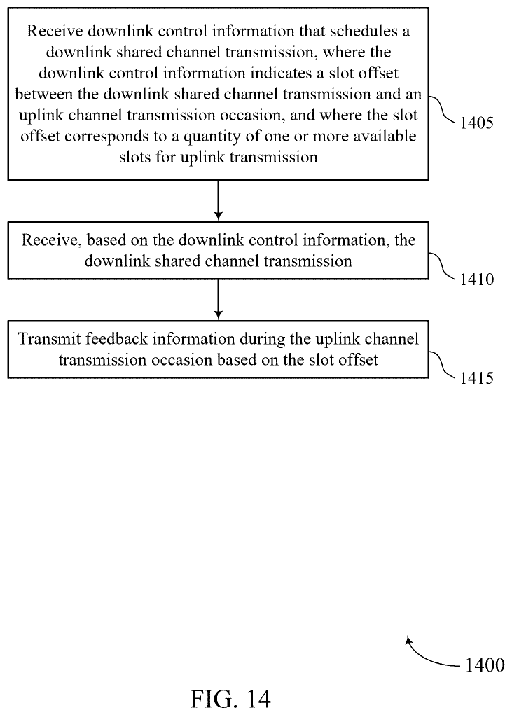

FIG. 14 shows a flowchart illustrating a method 1400 that supports available slot counting for hybrid automatic repeat request acknowledgement slot offset in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The operations of 1405 may be performed in accordance with examples as disclosed herein. In some examples, aspects of the operations of 1405 may be performed by a downlink control information component 825 as described with reference to FIG. 8.

At 1410, the method may include receiving, based on the downlink control information, the downlink shared channel transmission. The operations of 1410 may be performed in accordance with examples as disclosed herein. In some examples, aspects of the operations of 1410 may be performed by a downlink shared channel component 830 as described with reference to FIG. 8.

At 1415, the method may include transmitting feedback information during the uplink channel transmission occasion based on the slot offset. The operations of 1415 may be performed in accordance with examples as disclosed herein. In some examples, aspects of the operations of 1415 may be performed by a feedback component 835 as described with reference to FIG. 8.

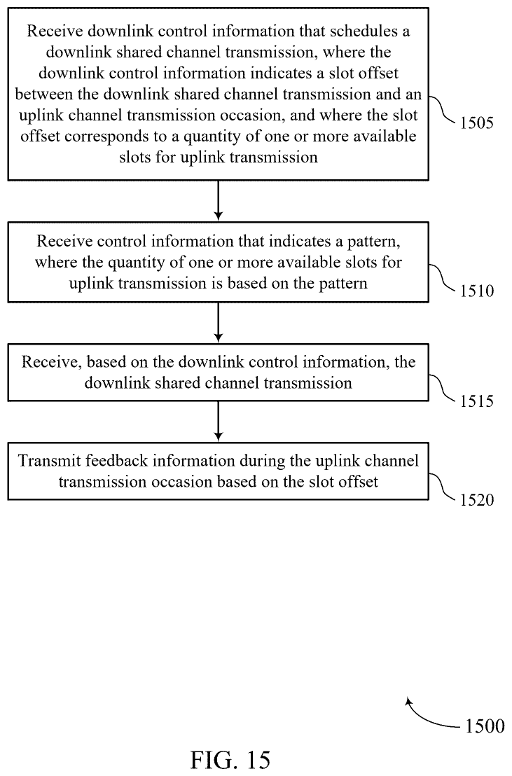

FIG. 15 shows a flowchart illustrating a method 1500 that supports available slot counting for hybrid automatic repeat request acknowledgement slot offset in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The operations of 1505 may be performed in accordance with examples as disclosed herein. In some examples, aspects of the operations of 1505 may be performed by a downlink control information component 825 as described with reference to FIG. 8.

At 1510, the method may include receiving control information that indicates a pattern, where the quantity of one or more available slots for uplink transmission is based on the pattern. The operations of 1510 may be performed in accordance with examples as disclosed herein. In some examples, aspects of the operations of 1510 may be performed by a pattern component 840 as described with reference to FIG. 8.

At 1515, the method may include receiving, based on the downlink control information, the downlink shared channel transmission. The operations of 1515 may be performed in accordance with examples as disclosed herein. In some examples, aspects of the operations of 1515 may be performed by a downlink shared channel component 830 as described with reference to FIG. 8.

At 1520, the method may include transmitting feedback information during the uplink channel transmission occasion based on the slot offset. The operations of 1520 may be performed in accordance with examples as disclosed herein. In some examples, aspects of the operations of 1520 may be performed by a feedback component 835 as described with reference to FIG. 8.

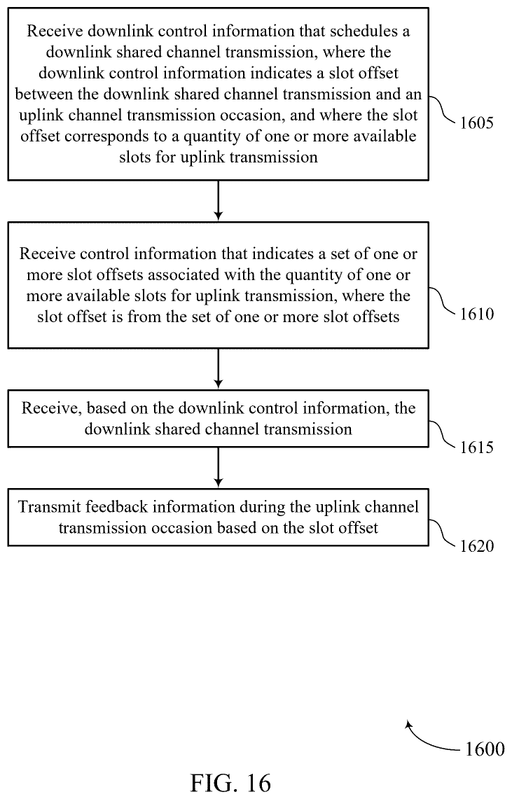

FIG. 16 shows a flowchart illustrating a method 1600 that supports available slot counting for hybrid automatic repeat request acknowledgement slot offset in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The operations of 1605 may be performed in accordance with examples as disclosed herein. In some examples, aspects of the operations of 1605 may be performed by a downlink control information component 825 as described with reference to FIG. 8.

At 1610, the method may include receiving control information that indicates a set of one or more slot offsets associated with the quantity of one or more available slots for uplink transmission, where the slot offset is from the set of one or more slot offsets. The operations of 1610 may be performed in accordance with examples as disclosed herein. In some examples, aspects of the operations of 1610 may be performed by a slot offset component 845 as described with reference to FIG. 8.

At 1615, the method may include receiving, based on the downlink control information, the downlink shared channel transmission. The operations of 1615 may be performed in accordance with examples as disclosed herein. In some examples, aspects of the operations of 1615 may be performed by a downlink shared channel component 830 as described with reference to FIG. 8.

At 1620, the method may include transmitting feedback information during the uplink channel transmission occasion based on the slot offset. The operations of 1620 may be performed in accordance with examples as disclosed herein. In some examples, aspects of the operations of 1620 may be performed by a feedback component 835 as described with reference to FIG. 8.

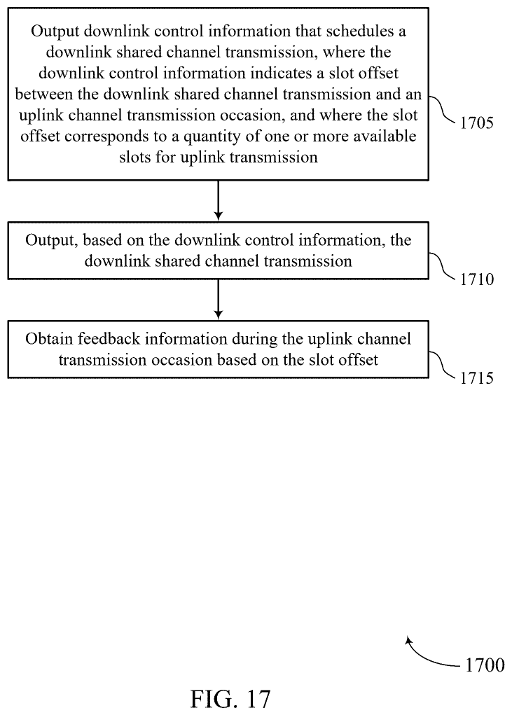

FIG. 17 shows a flowchart illustrating a method 1700 that supports available slot counting for hybrid automatic repeat request acknowledgement slot offset in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting downlink control information that schedules a downlink shared channel transmission, where the downlink control information indicates a slot offset between the downlink shared channel transmission and an uplink channel transmission occasion, and where the slot offset corresponds to a quantity of one or more available slots for uplink transmission. The operations of 1705 may be performed in accordance with examples as disclosed herein. In some examples, aspects of the operations of 1705 may be performed by a downlink control information manager 1225 as described with reference to FIG. 12.

At 1710, the method may include outputting, based on the downlink control information, the downlink shared channel transmission. The operations of 1710 may be performed in accordance with examples as disclosed herein. In some examples, aspects of the operations of 1710 may be performed by a downlink shared channel manager 1230 as described with reference to FIG. 12.

At 1715, the method may include obtaining feedback information during the uplink channel transmission occasion based on the slot offset. The operations of 1715 may be performed in accordance with examples as disclosed herein. In some examples, aspects of the operations of 1715 may be performed by a feedback manager 1235 as described with reference to FIG. 12.

The following provides an overview of aspects of the present disclosure:

Aspect 1: A method for wireless communication at a network entity, comprising: receiving downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission; receiving, based on the downlink control information, the downlink shared channel transmission; and transmitting feedback information during the uplink channel transmission occasion based on the slot offset.

Aspect 2: The method of aspect 1, wherein the downlink control information indicates the slot offset.

Aspect 3: The method of any of aspects 1 through 2, wherein each respective slot of the quantity of one or more available slots for uplink transmission comprises a respective plurality of symbols including at least one of one or more uplink symbols or one or more flexible symbols.

Aspect 4: The method of any of aspects 1 through 3, wherein each respective slot of the quantity of one or more available slots for uplink transmission comprises a respective set of one or more symbols that does not overlap with a synchronization signal block, each respective set of one or more symbols includes at least one of one or more uplink symbols or one or more flexible symbols.

Aspect 5: The method of any of aspects 1 through 4, wherein each respective slot of the quantity of one or more available slots for uplink transmission exclusively comprises uplink symbols, flexible symbols, or a combination thereof.

Aspect 6: The method of aspect 5, wherein each respective slot of the quantity of one or more available slots is non-overlapping with a synchronization signal block.

Aspect 7: The method of any of aspects 1 through 6, wherein each slot of the quantity of one or more available slots for uplink transmission exclusively comprises a quantity of uplink symbols, flexible symbols, or a combination thereof, that corresponds to the uplink channel transmission occasion.

Aspect 8: The method of aspect 7, wherein each respective slot of the quantity of one or more available slots is non-overlapping with a synchronization signal block.

Aspect 9: The method of any of aspects 1 through 8, wherein each slot of the quantity of one or more available slots for uplink transmission excludes downlink symbols or does not exclusively include downlink symbols.

Aspect 10: The method of any of aspects 1 through 9, further comprising: receiving control information that indicates a pattern, wherein the quantity of one or more available slots for uplink transmission is based on the pattern.

Aspect 11: The method of any of aspects 1 through 10, further comprising: receiving control information that indicates a set of one or more slot offsets associated with the quantity of one or more available slots for uplink transmission, wherein the slot offset is from the set of one or more slot offsets.

Aspect 12: The method of any of aspects 1 through 11, further comprising: determining a set of one or more downlink channel transmission occasions for a feedback codebook based on a set of differences between each slot index of a set of slot indexes and the slot offset, wherein the set of slot indexes corresponds to the set of one or more downlink channel transmission occasions.

Aspect 13: The method of any of aspects 1 through 12, further comprising: receiving control information; and performing, based on the control information, a semi-static cell switch between a primary cell and a secondary cell, wherein the quantity of one or more available slots for uplink transmission comprises available slots on at least one of the primary cell or the secondary cell.

Aspect 14: A method for wireless communication at a network entity, comprising: outputting downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission; outputting, based on the downlink control information, the downlink shared channel transmission; and obtaining feedback information during the uplink channel transmission occasion based on the slot offset.

Aspect 15: The method of aspect 14, wherein the downlink control information indicates the slot offset.

Aspect 16: The method of any of aspects 14 through 15, wherein each respective slot of the quantity of one or more available slots for uplink transmission comprise s a respective plurality of symbols including at least one of one or more uplink symbols or one or more flexible symbols.

Aspect 17: The method of any of aspects 14 through 16, wherein each respective slot of the quantity of one or more available slots for uplink transmission comprises a respective set of one or more symbols with a synchronization signal block, each respective set of one or more symbols includes at least one of one or more uplink symbols or one or more flexible symbols.

Aspect 18: The method of any of aspects 14 through 17, wherein each respective slot of the quantity of one or more available slots for uplink transmission exclusively comprises uplink symbols flexible symbols, or a combination thereof.

Aspect 19: The method of aspect 18, wherein each respective slot of the quantity of one or more available slots is non-overlapping with a synchronization signal block.

Aspect 20: The method of any of aspects 14 through 19, wherein each slot of the quantity of one or more available slots for uplink transmission exclusively comprises a quantity of uplink symbols, flexible symbols, or a combination thereof, that corresponds to the uplink channel transmission occasion.

Aspect 21: The method of aspect 20, wherein each respective slot of the quantity of one or more available slots is non-overlapping with a synchronization signal block.

Aspect 22: The method of any of aspects 14 through 21, wherein each slot of the quantity of one or more available slots for uplink transmission excludes downlink symbols or does not exclusively include downlink symbols.

Aspect 23: The method of any of aspects 14 through 22, further comprising: outputting control information that indicates a pattern, wherein the quantity of one or more available slots for uplink transmission is based on the pattern.

Aspect 24: The method of any of aspects 14 through 23, further comprising: outputting control information that indicates a set of one or more slot offsets associated with the quantity of one or more available slots for uplink transmission, wherein the slot offset is from the set of one or more slot offsets.

Aspect 25: The method of any of aspects 14 through 24, further comprising: determining a feedback codebook of the feedback information for a set of downlink channel transmission occasions based on a set of differences between each slot index of a set of slot indexes and the slot offset, wherein the set of slot indexes corresponds to the set of downlink channel transmission occasions.

Aspect 26: The method of any of aspects 14 through 25, further comprising: outputting control information; and performing, based on the control information, a semi-static cell switch between a primary cell and a secondary cell, wherein the quantity of one or more available slots for uplink transmission comprises available slots on at least one of the primary cell or the secondary cell.

Aspect 27: A network entity for wireless communication, comprising one or more memories storing processor-executable code, and one or more processors coupled with the one or more memories and individually or collectively operable to execute the code to cause the network entity to perform a method of any of aspects 1 through 13.

Aspect 28: A network entity for wireless communication, comprising at least one means for performing a method of any of aspects 1 through 13.

Aspect 29: A non-transitory computer-readable medium storing code for wireless communication, the code comprising instructions executable by one or more processors to perform a method of any of aspects 1 through 13.

Aspect 30: A network entity for wireless communication, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communication, comprising at least one means for performing a method of any of aspects 14 through 26.

Aspect 32: A non-transitory computer-readable medium storing code for wireless communication, the code comprising instructions executable by one or more processors to perform a method of any of aspects 14 through 26.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system configured to:
receive downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission;
receive, based on the downlink control information, the downlink shared channel transmission; and
transmit feedback information during the uplink channel transmission occasion based on the slot offset.

2. The network entity of claim 1, wherein the downlink control information indicates the slot offset.

3. The network entity of claim 1, wherein each respective slot of the quantity of one or more available slots for uplink transmission comprises a respective plurality of symbols including at least one of:
one or more uplink symbols; or
one or more flexible symbols.

4. The network entity of claim 1, wherein each respective slot of the quantity of one or more available slots for uplink transmission comprises a respective set of one or more symbols that does not overlap with a synchronization signal block, wherein each respective set of one or more symbols includes at least one of:
one or more uplink symbols; or
one or more flexible symbols.

5. The network entity of claim 1, wherein each respective slot of the quantity of one or more available slots for uplink transmission exclusively comprises uplink symbols, flexible symbols, or a combination thereof.

6. The network entity of claim 5, wherein each respective slot of the quantity of one or more available slots is non-overlapping with a synchronization signal block.

7. The network entity of claim 1, wherein each slot of the quantity of one or more available slots for uplink transmission exclusively comprises a quantity of uplink symbols, flexible symbols, or a combination thereof, that corresponds to the uplink channel transmission occasion.

8. The network entity of claim 7, wherein each respective slot of the quantity of one or more available slots is non-overlapping with a synchronization signal block.

9. The network entity of claim 1, wherein each slot of the quantity of one or more available slots for uplink transmission excludes downlink symbols or does not exclusively include downlink symbols.

10. The network entity of claim 1, wherein the processing system is configured to:
receive control information that indicates a pattern, wherein the quantity of one or more available slots for uplink transmission is based on the pattern.

11. The network entity of claim 1, wherein the processing system is configured to:
receive control information that indicates a set of one or more slot offsets associated with the quantity of one or more available slots for uplink transmission, wherein the slot offset is from the set of one or more slot offsets.

12. The network entity of claim 1, wherein the processing system is configured to:
determine a set of one or more downlink channel transmission occasions for a feedback codebook based on a set of differences between each slot index of a set of slot indexes and the slot offset, wherein the set of slot indexes corresponds to the set of one or more downlink channel transmission occasions.

13. The network entity of claim 1, wherein the processing system is configured to:
receive control information; and
perform, based on the control information, a semi-static cell switch between a primary cell and a secondary cell, wherein the quantity of one or more available slots for uplink transmission comprises available slots on at least one of:
the primary cell; or
the secondary cell.

14. A network entity, comprising:
a processing system configured to:
output downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission;
output, based on the downlink control information, the downlink shared channel transmission; and
obtain feedback information during the uplink channel transmission occasion based on the slot offset.

15. The network entity of claim 14, wherein the downlink control information indicates the slot offset.

16. The network entity of claim 14, wherein each respective slot of the quantity of one or more available slots for uplink transmission comprises a respective plurality of symbols including at least one of:
one or more uplink symbols; or
one or more flexible symbols.

17. The network entity of claim 14, wherein each respective slot of the quantity of one or more available slots for uplink transmission comprises a respective set of one or more symbols with a synchronization signal block, wherein each respective set of one or more symbols includes at least one of:
one or more uplink symbols; or
one or more flexible symbols.

18. The network entity of claim 14, wherein each respective slot of the quantity of one or more available slots for uplink transmission exclusively comprises uplink symbols flexible symbols, or a combination thereof.

19. The network entity of claim 18, wherein each respective slot of the quantity of one or more available slots is non-overlapping with a synchronization signal block.

20. The network entity of claim 14, wherein each slot of the quantity of one or more available slots for uplink transmission exclusively comprises a quantity of uplink symbols, flexible symbols, or a combination thereof, that corresponds to the uplink channel transmission occasion.

21. The network entity of claim 20, wherein each respective slot of the quantity of one or more available slots is non-overlapping with a synchronization signal block.

22. The network entity of claim 14, wherein each slot of the quantity of one or more available slots for uplink transmission excludes downlink symbols or does not exclusively include downlink symbols.

23. The network entity of claim 14, wherein the processing system is configured to:
output control information that indicates a pattern, wherein the quantity of one or more available slots for uplink transmission is based on the pattern.

24. The network entity of claim 14, wherein the processing system is configured to:
output control information that indicates a set of one or more slot offsets associated with the quantity of one or more available slots for uplink transmission, wherein the slot offset is from the set of one or more slot offsets.

25. The network entity of claim 14, wherein the processing system is configured to:
determine a feedback codebook of the feedback information for a set of downlink channel transmission occasions based on a set of differences between each slot index of a set of slot indexes and the slot offset, wherein the set of slot indexes corresponds to the set of downlink channel transmission occasions.

26. The network entity of claim 14, wherein the processing system is configured to:
output control information; and
perform, based on the control information, a semi-static cell switch between a primary cell and a secondary cell, wherein the quantity of one or more available slots for uplink transmission comprises available slots on at least one of:
the primary cell; or
the secondary cell.

27. A method of wireless communication performed by a network entity, comprising:
receiving downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission;
receiving, based on the downlink control information, the downlink shared channel transmission; and
transmitting feedback information during the uplink channel transmission occasion based on the slot offset.

28. The method of claim 27, further comprising:
receiving control information that indicates a pattern, wherein the quantity of one or more available slots for uplink transmission is based on the pattern.

29. A method of wireless communication performed by a network entity, comprising:
outputting downlink control information that schedules a downlink shared channel transmission, wherein the downlink control information indicates a slot offset between the downlink shared channel transmission and an uplink channel transmission occasion, and wherein the slot offset corresponds to a quantity of one or more available slots for uplink transmission;
outputting, based on the downlink control information, the downlink shared channel transmission; and
obtaining feedback information during the uplink channel transmission occasion based on the slot offset.

30. The method of claim 29, further comprising:
outputting control information that indicates a pattern, wherein the quantity of one or more available slots for uplink transmission is based on the pattern.
